(19) United States
(12) Patent Application Publication
(10) Pub. No.: US 2005/0263124 A1
(43) Pub. Date: Dec. 1, 2005

(54) Low cost vehicle air intake and exhaust handling devices manufactured from conductive loaded resin-based materials

(75) Inventor: Thomas Aisenbrey, Littleton, CO (US)

Correspondence Address: GEORGE O. SAILE, 28 DAVIS AVENUE, POUGHKEEPSTE, NY, 12603, US

(73) Assignee: Integral Technologies, Inc.

(21) Appl. No.: 11/180,015

(22) Filed: Jul. 12, 2005

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/587,288, filed on Jul. 12, 2004.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. F02M 35/10

(52) U.S. Cl. 123/184.61

(57) ABSTRACT

Vehicle air intake and exhaust handling devices are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application is related to U.S. patent application INT04-026B, Ser. No. ______, and filed on ______, which is herein incorporated by reference in its entirety.

This Patent Application claims priority to the U.S. Provisional Patent Application 60/587,288 filed on July 12, 2004, which is herein incorporated by reference in its entirety.

This Patent Application is a Continuation-in-Part of INT01-002CIPC, filed as U.S. patent application Ser. No. 10/877,092, filed on June 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to vehicle air intake and exhaust handling devices and, more particularly, to vehicle air intake and exhaust handling devices molded of conductive loaded resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

(2) Description of the Prior Art

Vehicle internal combustions engines operate as pumping systems wherein an air/fuel mixture is forced into the combustion chamber. After combustion, this mixture expands to cause the piston stroke. This burned mixture is later expelled from the chamber as exhaust gas. The movement of air into the engine is called intake and is accomplished by an intake system comprising components such as intake plenum or duct, intake manifold, throttle, turbo charger, air cleaner, and the like. The movement of air out of the engine is called exhaust and is accomplished by an exhaust system comprising components such as headers, tailpipes, mufflers, recirculation valves, and the like. Typically, intake manifolds are formed of cast metal while parts of the intake plenum and throttle are formed either of metal or, in some cases, a resin-based material. Typically, exhaust systems are steel tubing and stamped steel assemblies. A primary object of the present invention is to provide an alternative material and manufacturing method for vehicle intake and exhaust systems where this material has weight, reliability, and manufacturing advantages over the prior art.

Several prior art inventions relate to vehicle air intake and exhaust handling devices and related technologies. U.S. Pat. No. 5,630,387 to Kamiyama teaches an intake manifold having increased crash compaction manufactured in part of a resin based material. U.S. Pat. No. 5,704,326 to Minegishi et al teaches an air induction system for an internal combustion engine that utilizes air flow bodies and a collector body formed of a molded resin material. U.S. Pat. No. 6,234,132 B1 to Kopec et al teaches an air intake system for supplying intake air to an internal combustion engine made of a thermoplastic synthetic resin material. U.S. Pat. No. 6,584,946 B2 to Cardino et al teaches an intake manifold in which emitting noises are limited having an intake passage made of resin and metal. U.S. Pat. No. 5,730,096 to Atmur et al teaches a multi-fuel two-cycle engine employing structural fiber reinforced ceramic matrix composite (FRCMC) internal components. U.S. patent Publication US 2002/0168492 A1 to Madono et al teaches an inexpensive sound and heat insulating material coating layer of a lepidoflaky mineral for use in exhaust manifold covers, engine exhaust pipes and sound absorbing blocks. The coating layer is formed by coating and drying a water base dispersion of a lepidoflaky mineral on the surface of a base material mainly composed of a heat-resistant fiber such as an aromatic polyamide and polyimide, benzimidazole, silicone and metal chelate polymer. U.S. patent Publication US 2003/0232946 A1 to Pope et al teaches a process for synthesizing a photocurable pre-ceramic polymer for use in impregnation and/or coating of ceramic filters for use in combustion engine exhaust systems. U.S. Pat. No. 5,888,641 to Atmur et al teaches an exhaust manifold for an engine which is made of all fiber reinforced ceramic matrix composite material.

### SUMMARY OF THE INVENTION

A principal object of the present invention is to provide an effective vehicle air intake and exhaust handling devices.

A further object of the present invention is to provide a method to form vehicle air intake and exhaust handling devices.

A further object of the present invention is to provide vehicle air intake and exhaust handling devices molded of conductive loaded resin-based materials.

A yet further object of the present invention is to provide vehicle air intake and exhaust handling devices molded of conductive loaded resin-based material where the thermal, acoustical, or electrical characteristics can be altered or the visual characteristics can be altered by forming a metal layer over the conductive loaded resin-based material.

A yet further object of the present invention is to provide methods to fabricate vehicle air intake and exhaust handling devices from a conductive loaded resin-based material incorporating various forms of the material.

A yet further object of the present invention is to provide a method to fabricate vehicle air intake and exhaust handling devices from a conductive loaded resin-based material where the material is in the form of a fabric.

In accordance with the objects of this invention, a vehicle engine air intake device is achieved. The device comprises a hollow air transporting structure comprising a conductive loaded, resin-based material comprising conductive materials in a base resin host.

Also in accordance with the objects of this invention, a vehicle engine exhaust device is achieved. The device comprises a hollow exhaust transporting structure comprising a conductive loaded, resin-based material comprising conductive materials in a base resin host. The percent by weight of the conductive materials is between about 20% and about 50% of the total weight of the conductive loaded resin-based material.

Also in accordance with the objects of this invention, a vehicle engine air intake device is achieved. The device comprises a hollow air transporting structure comprising a conductive loaded, resin-based material comprising micron conductive fiber in a base resin host. The percent by weight of the micron conductive fiber is between about 20% and about 50% of the total weight of the conductive loaded resin-based material.

Also in accordance with the objects of this invention, a method to form vehicle engine air intake device is achieved. The method comprises providing a conductive loaded, resin-based material comprising conductive materials in a resin-based host. The conductive loaded, resin-based material is molded into a vehicle engine air intake device comprising a hollow air transporting structure.

Also in accordance with the objects of this invention, a method to form a vehicle engine air intake device is achieved. The method comprises providing a conductive loaded, resin-based material comprising conductive materials in a resin-based host. The percent by weight of the conductive materials is between 20% and 40% of the total weight of the conductive loaded resin-based material. The conductive loaded, resin-based material is molded into a vehicle engine air intake device comprising a hollow air transporting structure.

Also in accordance with the objects of this invention, a method to form a vehicle engine air intake device is achieved. The method comprises providing a conductive loaded, resin-based material comprising micron conductive fiber in a resin-based host. The percent by weight of the micron conductive fiber is between 20% and 50% of the total weight of the conductive loaded resin-based material. The conductive loaded, resin-based material is molded into a vehicle engine air intake device comprising a hollow air transporting structure.

### BRIEF DESCRIPTION OF THE DRAWINGS

In the accompanying drawings forming a material part of this description, there is shown:

FIG. 1 illustrates a first preferred embodiment of the present invention showing a single point injection, vehicle air intake manifold comprising conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold vehicle air intake and exhaust handling devices of a conductive loaded resin-based material.

FIG. 7 illustrates a second preferred embodiment of the present invention showing a conductive loaded resin-based material air intake system.

FIG. 8 illustrates a third preferred embodiment of the present invention showing a vehicle exhaust manifold comprising conductive loaded resin-based material.

FIG. 9 illustrates a fourth preferred embodiment of the present invention showing a conductive loaded resin-based material turbo charger.

FIG. 10 illustrates a fifth preferred embodiment of the present invention showing a muffler comprising conductive loaded resin-based material.

FIG. 11 illustrates a sixth preferred embodiment of the present invention showing an exhaust system comprising conductive loaded resin-based material of the present invention.

FIG. 12 illustrates a seventh preferred embodiment of the present invention showing an air distribution duct system comprising conductive loaded resin-based material.

FIG. 13 illustrates an eighth preferred embodiment of the present invention showing a conductive loaded resin-based material throttle valve.

### DESCRIPTION OF THE PREFERRED EMBODIMENTS

This invention relates to vehicle air intake and exhaust handling devices molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical, thermal, and/or acoustical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of vehicle air intake and exhaust handling devices fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the vehicle air intake and exhaust handling devices are substantially homogenized together using molding techniques and or methods such as injection molding, over-molding, insert molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of vehicle air intake and exhaust handling devices significantly lowers the cost of materials and the design and manufacturing processes used to hold ease of close tolerances, by forming these materials into desired shapes and sizes. The vehicle air intake and exhaust handling devices can be manufactured into infinite shapes and sizes using conventional forming methods such as injection molding, over-molding, or extrusion, calendaring, or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. Exemplary micron conductive powders include carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductive loaded resin-based material. The addition of conductive powder to the micron conductive fiber loading may increase the surface conductivity of the molded part, particularly in areas where a skinning effect occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

The structural material may be any polymer resin or combination of polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductive loaded resin-based material. Many different dielectric properties are possible depending on the chemical makeup and/or arrangement, such as linking, cross-linking or the like, of the polymer, co-polymer, or monomer material. Structural material can be, here given as examples and not as an exhaustive list, polymer resins produced by GE PLASTICS, Pittsfield, MA, a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion, or compression molding, or calendaring, to create desired shapes and sizes. The molded conductive loaded resin-based materials can also be stamped, cut or milled as desired to form create the desired shape form factor(s) of the vehicle air intake and exhaust handling devices. The doping composition and directionality associated with the micron conductors within the loaded base resins can affect the electrical and structural characteristics of the device and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming vehicle air intake and exhaust handling devices. When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in vehicle air intake and exhaust handling device applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, vehicle air intake and exhaust handling devices manufactured from the molded conductor loaded resin-based material can provide added thermal dissipation capabilities to the application. For example, heat can be dissipated from electrical devices physically and/or electrically connected to a device of the present invention.

As a significant advantage of the present invention, vehicle air intake and exhaust handling devices constructed of the conductive loaded resin-based material can be easily interfaced to an electrical circuit or grounded. In one embodiment, a wire can be attached to a conductive loaded resin-based device via a screw that is fastened to the device. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the vehicle air intake and exhaust handling device and a grounding wire.

Where a metal layer is formed over the surface of the conductive loaded resin-based material, any of several techniques may be used to form this metal layer. This metal layer may be used for visual enhancement of the molded conductive loaded resin-based material article or to otherwise alter performance properties. Well-known techniques, such as electroless metal plating, electro metal plating, sputtering, metal vapor deposition, metallic painting, or the like, may be applied to the formation of this metal layer. If metal plating is used, then the resin-based structural material of the conductive loaded, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

The ferromagnetic conductive loading is in the form of fiber, powder, or a combination of fiber and powder. The micron conductive powder may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive loading may be combined with a non-ferromagnetic conductive loading to form a conductive loaded resin-based material that combines excellent conductive qualities with magnetic capabilities.

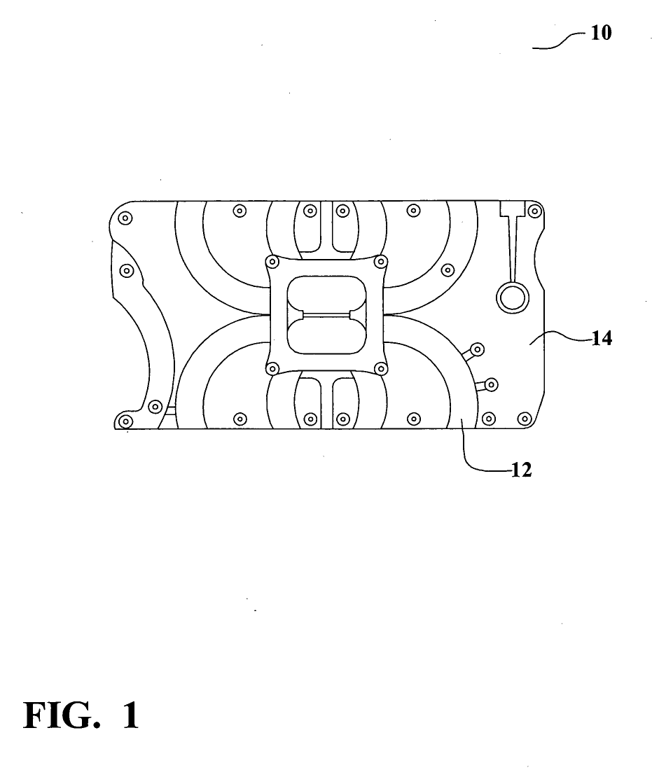

Referring particularly to FIG. 1, a first preferred embodiment of the present invention is illustrated. A manifold 10 for a single point carburetor-based or throttle body based injection system is shown. This manifold 10 is constructed to hold a carburetor or a single point injection device, such as a throttle body injector, not shown, wherein air and fuel are mixed at the central intake point of the manifold 10 and then ported through individual passages 12 to each cylinder. The intake manifold 10 of the present invention comprises conductive loaded resin-based material. The manifold comprises an outer housing and internal components or chambers used to direct the flow of intake air. In another embodiment, the intake manifold is designed for a multipoint injection system. In the multipoint system, the flow of air is controlled entering the intake of the manifold. This air is then ported to individual cylinders by porting tubes molded into the manifold housing. A fuel rail routes fuel to a series of fuel injectors located at the outlets of each port. In this embodiment, the porting tubes, manifold housing, and/or fuel rail are formed of the conductive loaded resin-based material of the present invention. A variety of other intake manifold configurations can be easily molded of the conductive loaded resin-based material of the present invention.

Referring again to FIG. 1, the conductive loaded resin-based material is preferably used to form the outer housing 104 as well as internal components, not shown, of the intake manifold 10. Such internal components include but are not limited to those devices used to direct the flow of intake air, those devices used to increase the effective intake tube length, and devices used to increase or decrease the amount of intake air flowing to the engine based on engine speed. In one preferred embodiment, internal devices are integrally molded into the outer housing 14. One such example is the air passage 12 which is also visible in the outer housing. In a second preferred embodiment, the internal components are formed separately and then introduced into the intake manifold 10 by means of over-molding or discrete attachment. In yet another preferred embodiment, conductive loaded resin-based material is over-molded around a metal portion provided with fittings for mounting the conductive loaded resin-based material intake manifold 10 to the engine. Preferably, the intake manifold 10 is designed and attached to the engine in such a manner as to enable the intake manifold 10 to absorb energy during vehicle impact. Conductive loaded resin-based material is suitable for this purpose.

The conductive loaded resin-based material vehicle air intake manifold 10 offers numerous advantages over the cast metal manifold found in prior art. One significant advantage is the cost reduction realized in fabricating the intake manifold 10 of conductive loaded resin-based material. As discussed heretofore, conductive loaded resin-based material may be formed into almost any shape and size using conventional molding techniques. This provides a very cost effective fabrication process in comparison to cast metals which often require machining after the casting process. A second important advantage of the conductive loaded resin-based material intake manifold 10 of the present invention is weight. Conductive loaded resin-based materials weigh significantly less per device than do metals. This results in reduced vehicle weight. Reduced vehicle weight translates to increased fuel economy and increased customer satisfaction. The reduced weight of the conductive loaded resin-based material air intake manifold 100 also results in cost savings during component shipping and handling. As a further advantage of the present invention, the conductive loaded resin-based material air intake manifold 100 provides noise reduction by absorbing and attenuating sound waves. Such sound reduction is an inherent property of the conductive loaded resin-based material of the present invention. Further, this material provides protection from interfering electromagnetic waves by absorbing the undesirable electromagnetic interference (EMI) and radio frequency interference (RFI). Another significant advantage of the conductive loaded resin-based material air intake manifold 100 is the smoothness of the interior surfaces. Conductive loaded resin-based material, once molded and cured, provides an appreciably smoother surface than the metals conventionally used. The smooth surface of the present invention results in less friction being introduced at the interface to the passing air. That is, the use of conductive loaded resin-based material reduces air resistance. Thus, it provides a more efficient and effective air intake and exhaust system.

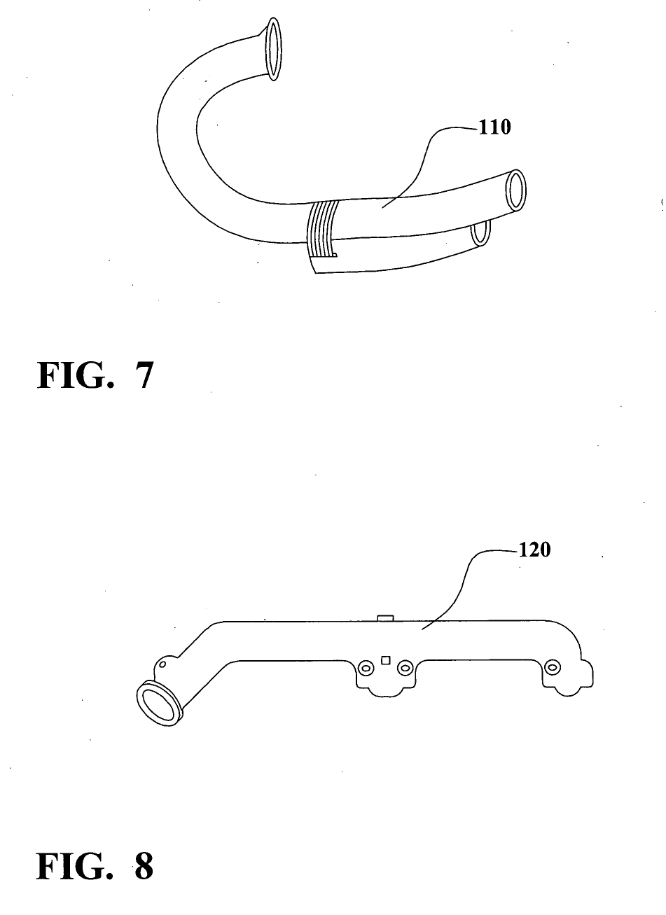

Referring now to FIG. 7, a second preferred embodiment of the present invention is illustrated. An air intake duct system 110 comprising conductive loaded resin-based material is shown. The embodiment represents only one example of the many shapes, forms, and types of vehicle air ducting that may be formed of conductive loaded resin-based material. The word ducting is used herein to describe plenums, tubes, pipes, ducts, hoses and/or other devices which may be used to transport or otherwise direct the flow of intake and/or exhaust air. Conductive loaded resin-based material provides many advantages over conventional metal and/or plastic materials commonly used for ducting applications. Conductive loaded resin-based material ducts are easily extruded and formed in any shape and size that is desired for the particular vehicle application. This results in low cost, reduced weight, dimensionally accurate ducting that is well-suited for vehicle air intake and exhaust applications. Air resistance against the duct sidewalls is also reduced by the use of conductive loaded resin-based material. Further benefits include noise reduction and EMI/RFI absorption.

Referring now to FIG. 8, a third preferred embodiment of the present invention is illustrated. An exhaust manifold 120 comprising conductive loaded resin-based material is shown. The exhaust manifold 120 is used to route engine exhaust air from the internal combustion engine to the other components that will process the exhaust air before it is finally expelled from the vehicle. The exhaust manifold is required to withstand relatively high temperatures. This is due to the fact that heat is generated by the engine and passed on through the exhaust air as well as through physical contact and radiation from the engine. Therefore, the base resin and conductive loading particles of the conductive loaded resin-based material are selected from those which are able to withstand the temperature range required by the exhaust air and the engine environment. Conductive loaded resin-based material of the present invention provides an exhaust manifold 120 that is significantly lower in cost, weight, and air resistance than the conventional metal exhaust manifold.

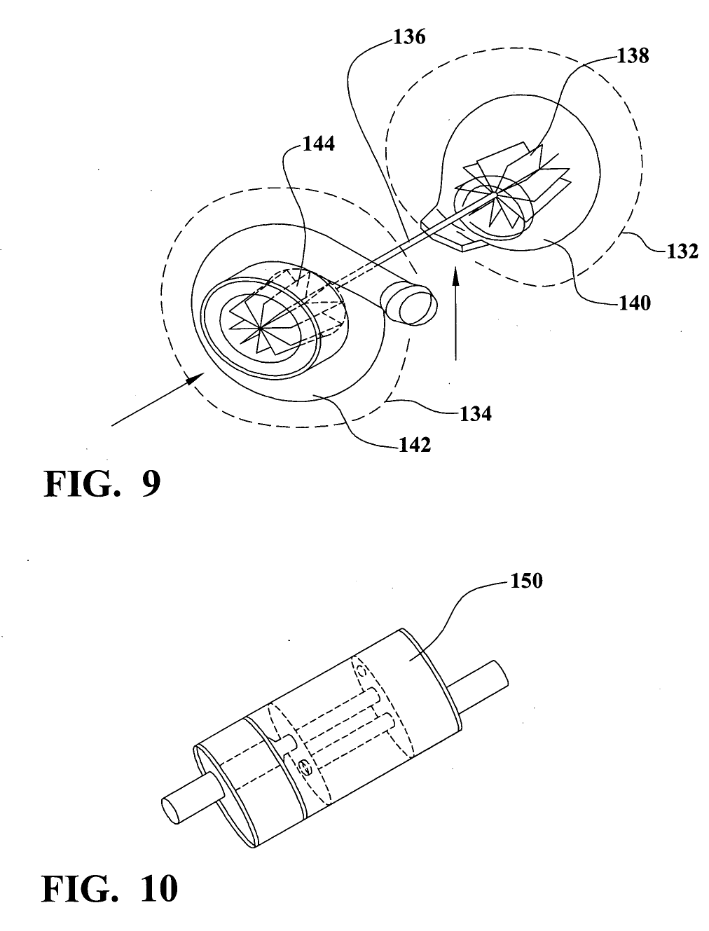

Referring now to FIG. 9, a fourth preferred embodiment of the present invention is illustrated. A turbo charger system comprising conductive loaded resin-based material is shown. The turbo charger commonly comprises a compressor portion 134, a turbine portion 132 and a connecting shaft portion 136. The turbine section 132 comprises an exhaust gas-driven turbine wheel 138, a wheel heat shroud, not shown, and a turbine housing 140. The compressor portion 134 comprises a compressor wheel 144, a backplate, not shown, and a compressor housing 142. The connecting shaft portion 136 comprises an internal shaft enclosed in a housing. In a common turbo charger scenario, expanded engine exhaust gas is directed through the exhaust manifold into the turbine housing 140. The exhaust gas pressure and the heat energy extracted from the gas causes the turbine wheel 138 to rotate which drives the compressor wheel 144. Exhaust gas pressures and temperatures drop as they pass the turbine wheel and are then routed into the atmosphere. In one preferred embodiment, all of the aforementioned turbo charger components comprise conductive loaded resin-based material. In another embodiment, the turbine housing 140, compressor housing 142, shaft housing, not shown, compressor wheel 144, and turbine wheel 138 comprise conductive loaded resin-based material. In yet another embodiment, only the housings 140 and 142 and the shaft housing comprise conductive loaded resin-based material. The conductive loaded resin-based material turbo charger 130 of the present invention is advantageous in several important ways. The invention provides a cost and weight savings compared to conventional metal turbo chargers, provides aerodynamic flow of air throughout the turbo charger, and offers noise reduction, EMI/RFI absorption and heat transfer properties inherent to conductive loaded resin-based material.

Referring now to FIG. 10, a fifth preferred embodiment of the present invention is illustrated. A conductive loaded resin-based material vehicle muffler 150 is shown. A muffler is a device commonly used to reduce the sound level of the air leaving the vehicle. In the case of vehicle exhaust, sound can be described as a pressure wave formed by pulses of alternating high and low air pressure. The alternating high and low air pressure is generated by the engine exhaust valves as they open to expel a burst of high pressure gas into the lower pressure exhaust system. The repetition of engine exhaust valves opening and closing creates alternately high pressure and low pressure in the exhaust gas along the exhaust system. This process creates an extreme amount of sound. Hence a muffler is needed to reduce the sound level emitted by the vehicle. Typical mufflers in use today comprise a collection of tubes, holes, and chambers designed to reflect sound waves in such a way as to cause partial cancellation and, therefore, noise attenuation. These prior art mufflers are fabricated of metal components. The conductive loaded resin-based material muffler 150 of the present invention is designed to attenuate sound. The material of the present invention has the advantage of being capable of absorbing sound waves. Conductive loaded resin-based material mufflers such as the exemplary muffler 150 are precision designed so as to maximize sound reduction by both absorbing sound and reflecting sound within the muffler. This provides excellent noise reduction. The conductive loaded resin-based material muffler 150 also provides the significant advantages of reduced cost and weight.

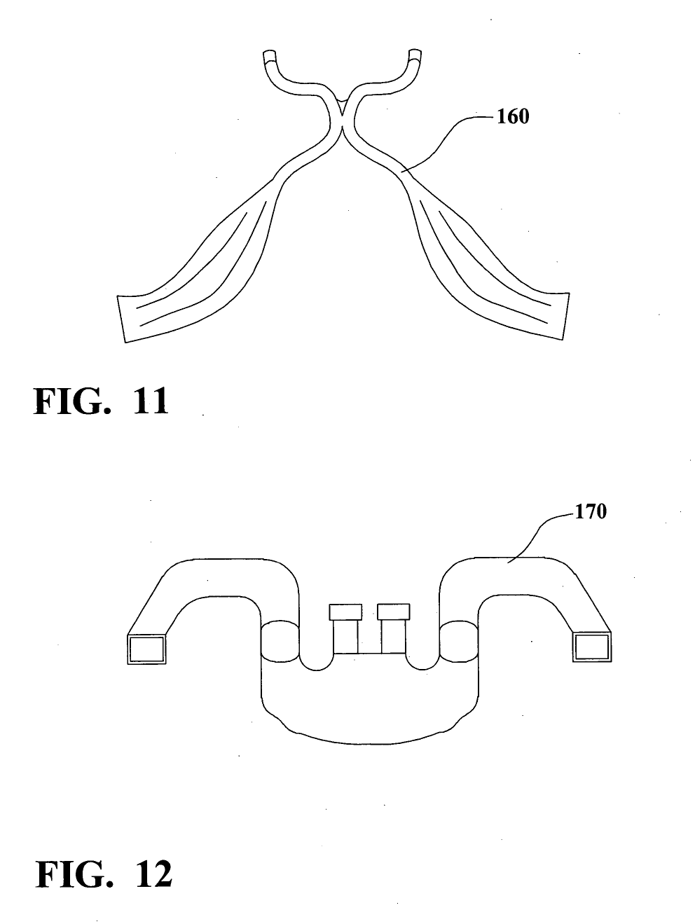

Referring now to FIG. 11, a sixth preferred embodiment of the present invention is illustrated. An exemplary race car exhaust system 160 is shown. Race cars do not utilize conventional mufflers because mufflers introduce significant backpressure which would hinder the race car engine performance. Instead, race cars generally utilize an exhaust system which is analogous to a single pipe coated with a sound absorbing material. In one preferred embodiment, the race car exhaust system 160 of FIG. 11 comprises conductive loaded resin-based material. In a second preferred embodiment, the race car exhaust system 160 comprises a metal exhaust pipe which is over-molded with conductive loaded resin-based material. In both embodiments, the conductive loaded resin-based material of the present invention serves to attenuate and absorb sound as the exhaust travels through the exhaust system 160. The conductive loaded resin-based material comprises a resin host and conductive loading particles which are suited to the temperature extremes of the race car exhaust environment. Again, conductive loaded resin-based material offers substantial advantages including lower cost, lower weight, and smooth interior finish.

Referring now to FIG. 12, a seventh preferred embodiment of the present invention is illustrated. An air distribution duct system 170 is shown. This represents duct systems which carry air to the vehicle passenger compartment. The air distribution duct system 170 comprises conductive loaded resin-based material. This material of the present invention provides an air distribution system 170 that is easily formed using conventional molding techniques. It provides cost advantages and is light weight, sound absorbing, EMI/RFI absorbing.

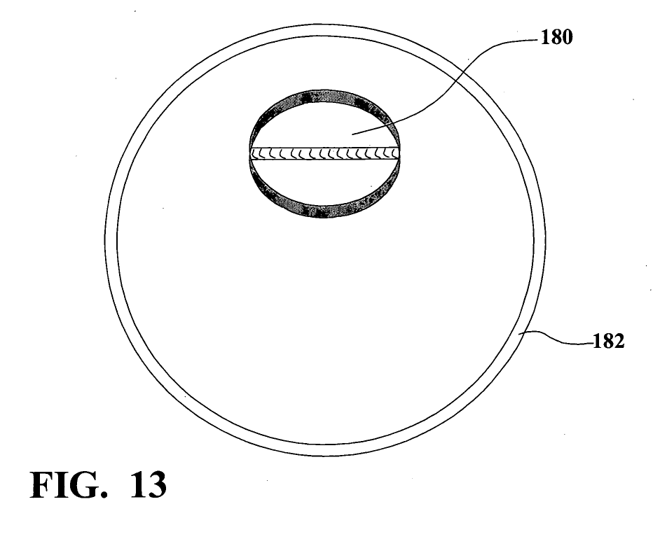

Referring now to FIG. 13, an eighth preferred embodiment of the present invention is illustrated. A throttle valve 180 comprising conductive loaded resin-based material is shown. The throttle valve is used in vehicles to regulate the quantity of air entering the engine. The throttle valve door 182 opens further to allow more air to flow to the engine when the gas pedal is depressed. Conversely, the throttle valve door 182 pivots toward closed when less air is required. The conductive loaded resin-based material throttle valve 180 offers significant advantages. These advantages include low cost, reduced weight, EMI/RFI absorption, noise attenuation, and smooth surface finish which maximizes aerodynamics.

Other vehicle air intake and exhaust handling devices of the present invention include, but are not limited to cowling, pipes/tubes, air filter covers, intercooler, and other such components comprising conductive loaded resin-based material.

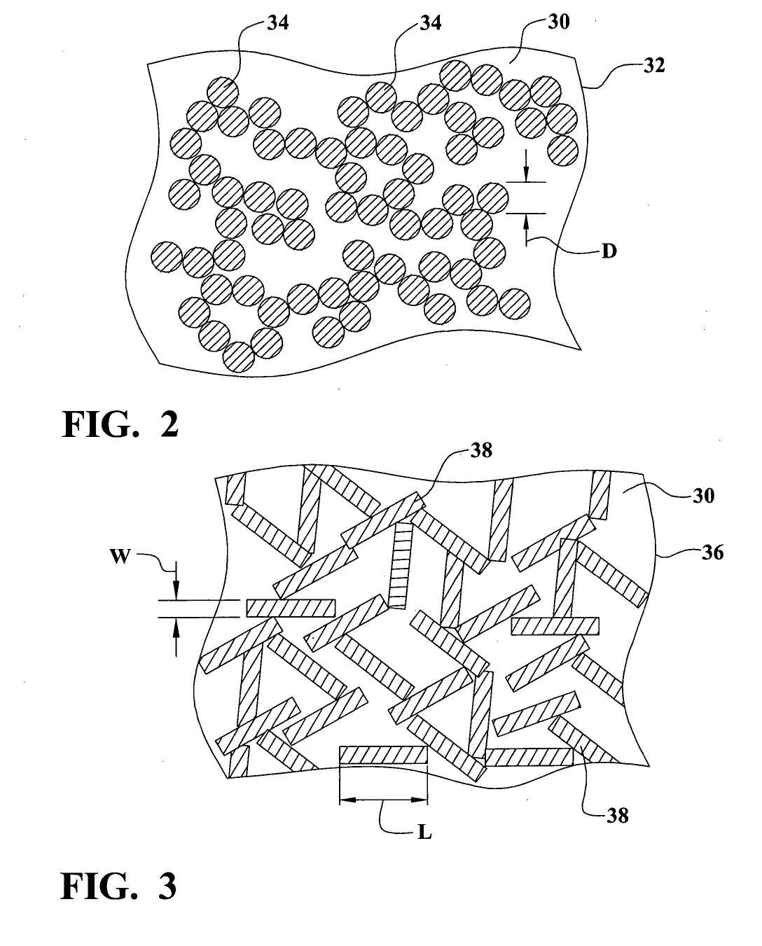

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

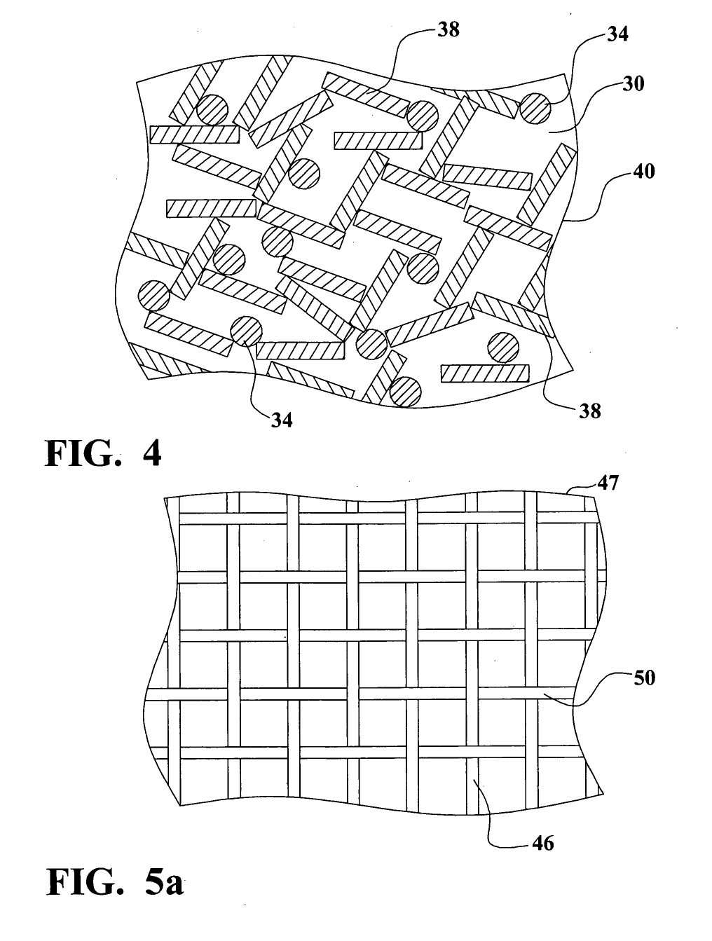

These conductor particles and/or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF, thermal, acoustic, or electronic spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

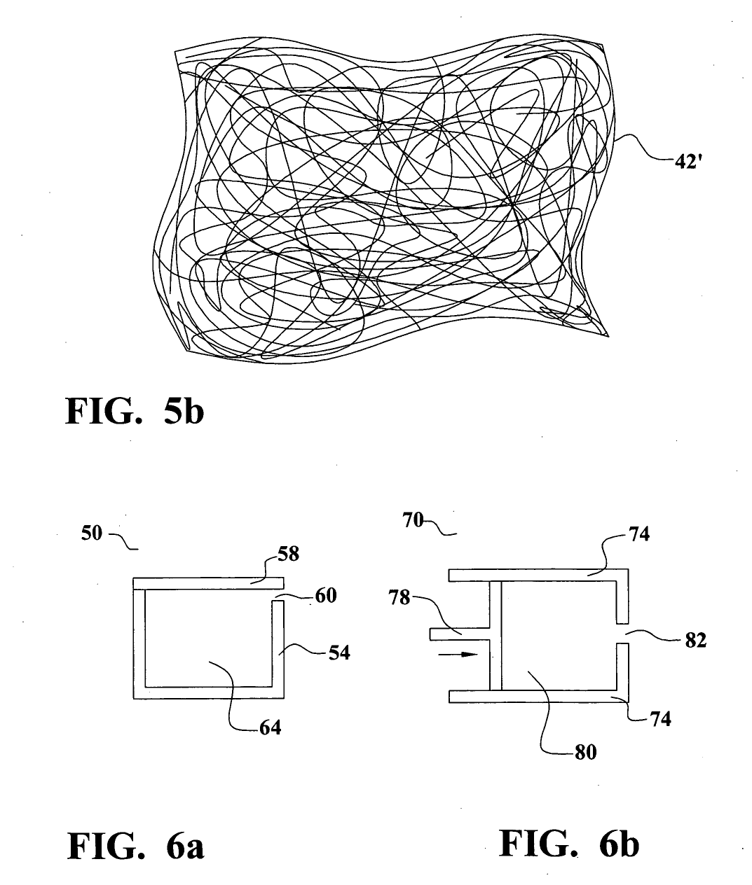

Vehicle air intake and exhaust handling devices formed from conductive loaded resin-based materials can be formed or molded in a number of different ways including injection molding, extrusion, calendaring, or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the devices are removed.

FIG. 6b shows a simplified schematic diagram of an extruder 70 for forming vehicle air intake and exhaust handling devices using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective vehicle air intake and exhaust handling device is achieved. A method to form vehicle air intake and exhaust handling devices is achieved. The vehicle air intake and exhaust handling devices are molded of conductive loaded resin-based materials. The thermal, acoustical, or electrical characteristics can be altered or the visual characteristics can be altered by forming a metal layer over the conductive loaded resin-based material. Methods to fabricate vehicle air intake and exhaust handling devices from a conductive loaded resin-based material incorporate various forms of the material. A method is achieved to fabricate vehicle air intake and exhaust handling devices from a conductive loaded resin-based material where the material is in the form of a fabric.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

What is claimed is:

1. A vehicle engine air intake device comprising a hollow air transporting structure comprising a conductive loaded, resin-based material comprising conductive materials in a base resin host.

2. The device according to claim 1 wherein the percent by weight of said conductive materials is between about 20% and about 50% of the total weight of said conductive loaded resin-based material.

3. The device according to claim 1 wherein said conductive materials comprise micron conductive fiber.

4. The device according to claim 2 wherein said conductive materials further comprise conductive powder.

5. The device according to claim 1 wherein said conductive materials are metal.

6. The device according to claim 1 wherein said conductive materials are non-conductive materials with metal plating.

7. The device according to claim 1 further comprising an outer layer that is not electrically conductive.

8. The device according to claim 7 wherein said outer layer comprises a resin-based material.

9. The device according to claim 1 wherein said hollow structure is a pipe or hose.

10. The device according to claim 1 wherein said hollow structure is a manifold.

11. The device according to claim 1 wherein said hollow structure is the housing of a turbo charger.

12. The device according to claim 1 wherein said hollow structure is the housing of a throttle valve.

13. A vehicle engine exhaust device comprising a hollow exhaust transporting structure comprising a conductive loaded, resin-based material comprising conductive materials in a base resin host wherein the percent by weight of said conductive materials is between about 20% and about 50% of the total weight of said conductive loaded resin-based material.

14. The device according to claim 13 wherein said conductive materials are nickel plated carbon micron fiber, stainless steel micron fiber, copper micron fiber, silver micron fiber or combinations thereof.

15. The device according to claim 13 wherein said conductive materials comprise micron conductive fiber and conductive powder.

16. The device according to claim 15 wherein said conductive powder is nickel, copper, or silver.

17. The device according to claim 15 wherein said conductive powder is a non-metallic material with a metal plating.

18. The device according to claim 13 wherein said hollow structure is an exhaust manifold.

19. The device according to claim 13 wherein said hollow structure is a muffler.

20. The device according to claim 13 wherein said conductive loaded resin-based material further comprises a ferromagnetic material.

21. A vehicle engine air intake device comprising a hollow air transporting structure comprising a conductive loaded, resin-based material comprising micron conductive fiber in a base resin host wherein the percent by weight of said micron conductive fiber is between about 20% and about 50% of the total weight of said conductive loaded resin-based material.

22. The device according to claim 21 wherein said micron conductive fiber is stainless steel.

23. The device according to claim 21 wherein said micron conductive fiber has a diameter of between about 3 μm and about 12 μm and a length of between about 2 mm and about 14 mm.

24. The device according to claim 21 further comprising a metal plating overlying said conductive loaded resin-based material.

25. The device according to claim 21 wherein said hollow structure is a pipe or hose.
